(19) United States
(12) Patent Application Publication
(10) Pub. No.: US 2007/0129014 A1
(43) Pub. Date: Jun. 7, 2007

(54) Information synchronization

(75) Inventors: Pablo Martin Rodriguez Bertorello, Buenos Aires (AR); Anibal Cucco, Rio Cuarto (AR); Maximilliano Carradori, Rio Cuarto (AR); Martin Perez, Rio Cuarto (AR); Nicolas Florio, Rio Cuarto (AR); Gabriel Salicio, Rio Cuarto (AR); Paulo Magnago, Rio Cuarto (AR)

Correspondence Address: MANNAVA & KANG, P.C., 8221 Old Courthouse Road, Suite 104, Vienna, VA, 22182, US

(73) Assignee: Bertorello, Inc.

(21) Appl. No.: 11/602,153

(22) Filed: Nov. 20, 2006

Related U.S. Application Data
(60) Provisional application No. 60/737,856, filed on Nov. 18, 2005.

(51) Int. Cl. H04B 7/00

(52) U.S. Cl. 455/41.2

(57) ABSTRACT

Actions from multiple devices are synchronized to generate a representation that may be used for collaboration. Synchronization may include a roll-back procedure that allows an action on the representation, which may have been performed by another device at an earlier time, to be included in the representation. Also, a non-user of an application may be invited to use the application through an automated procedure that downloads and installs the application and establishes communication with the sender of the invitation, causing the new user to have an up-to-date representation. The automated procedure may be invoked by a single click on the invitation.

This patent application claims priority under 35 U.S.C. § 119(e) of U.S. provisional application 60/737,856, filed Nov. 18, 2005, by Bertorello et al.

### BACKGROUND

Previous efforts to provide a secure ad-hoc collaboration environment have been ineffective, particularly for organizations of highly mobile or distributed people who need information within reach at all times even when they don't have an Internet connection.

Establishing secure ad-hoc networks or simply establishing connections or otherwise communicating with known users via existing networks using known techniques, requires a user to perform several steps. If communication is to be established in a hazardous environment, such as during a rescue mission or on a battlefield, there may not be time to perform several steps to establish communication or to determine an exact username or ID of person that needs to be communicated with.

Furthermore, once communication is established, conventional techniques for collaborating with multiple users to share information sometimes fall short. Collaboration typically requires different people to make manual changes to the same document or set of documents and store the documents with the changes locally until the people can collaborate again. The documents may be organized in a file system on a user device. Changes may include changes to the stored documents in the file system, such as moving documents or files to different folders, which may represent directories, deleting documents, adding new documents, etc. These changes may represent or be associated with decisions of the user. For example, in a rescue operation, certain files may represent different areas that are being searched. After searching an area and not finding the target of the rescue, the user may move a file associated with that area to a folder named “Searched Areas”. When the users collaborate after searching, they may manually open each folder and determine what files were moved to what folder by each user to determine all the areas that were searched and not searched. If there are many folders representing many different types of decisions and many files, this manual process can be very time consuming, and result in a loss of critical time that may be used to search for the target.

### SUMMARY

Actions from multiple devices are synchronized to generate a representation that may be used for collaboration. Synchronization may include a roll-back procedure that allows an action on the representation, which may have been performed by another device at an earlier time, to be included in the representation. Also, a non-user of an application may be invited to use the application through an automated procedure that downloads and installs the application and establishes communication with the sender of the invitation, causing the new user to have an up-to-date representation. The automated procedure may be invoked by a single click on the invitation.

### BRIEF DESCRIPTION OF THE DRAWINGS

Various features of the embodiments can be better appreciated, at the same time become better understood with reference to the following detailed description when considered in connection with the accompanying figures, in which:

FIG. 1 illustrates a system, according to an embodiment;

FIGS. 2-4 illustrate examples of hierarchies, according to an embodiment;

FIG. 5 illustrates a flow chart of a method for synchronizing action to generate a representation of a hierarchy, according to an embodiment;

FIG. 6 illustrates a data flow diagram for synchronizing actions, according to an embodiment;

FIG. 7 illustrates an example of an XML representation of a hierarchy, according to an embodiment;

FIG. 8 illustrates an example of a graph of document versions, according to an embodiment;

FIG. 9 illustrates an example of a table of document versions, according to an embodiment;

FIG. 10 illustrates a data model for versioning, according to an embodiment;

FIG. 11 illustrates an invitation according to an embodiment;

FIG. 12 illustrates a method for inviting a non-user of an application, according to an embodiment; and

FIG. 13 illustrates a computer system, according to an embodiment;

### DETAILED DESCRIPTION OF THE EMBODIMENTS

In the following detailed description, references are made to the accompanying figures, which illustrate specific embodiments. Electrical, mechanical, logical and structural changes may be made to the embodiments without departing from the spirit and scope of the embodiments.

According to embodiments described herein, systems and methods are described that allow users to quickly and easily establish communication and collaborate with each other on a project. For example, users can send others one-click invitations to join work spaces. Invitees can accept or decline invitations, and even block inviters, preventing spam. Also, people can take on modifiable user names that can reflect ways in which they are known, such as their email address.

Furthermore, the embodiments allow for users to share information in a secure and natural way. Also, shared information may be synchronized, such that even after several different users make changes to the same document or the same workspace at different times, the document or workspace may be organized and represented such that all the users have the same representation of the workspace or the document.

Information shared by users is organized in ways in which they would expect based on their use of operating systems such as Windows, such as hierarchically with projects and workspaces within. Information hierarchies can be automatically synchronized among users and across user computers. Thus, in certain situations where time is critical, users can quickly establish communication with each other and share information with each other, for example, through automated synchronization, to allow for easy collaboration on a single project or goal.

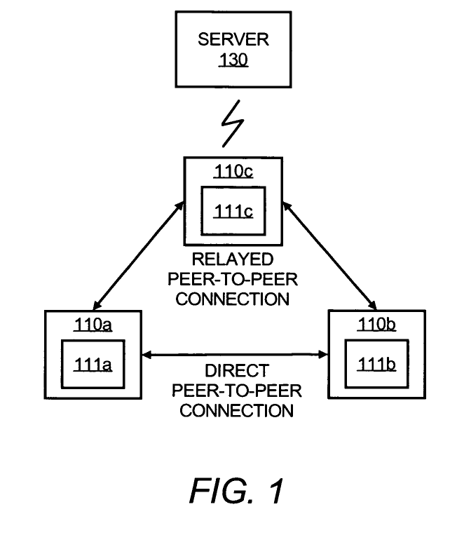

FIG. 1 illustrates a system 100, according to an embodiment. The system 100 may include a peer-to-peer architecture. FIG. 1 shows nodes 110a-c connected via a peer-to-peer connection. Peer-to-peer connections may be established through one or more networks. The networks may include the Internet or other wide area networks and/or local area or ad-hoc networks. Nodes may include any type of computing device with an interface for communicating with other devices, such as laptops, personal digital assistants, cellular phones, personal computers, servers, etc. One or more of the nodes may be portable. Client applications 111a-c may be provided for exchanging information via a peer-to-peer connection. The client applications 111a-c may each include one or more applications for establishing peer-to-peer and/or other network connections and for performing other functions and methods described below. For example, the client applications 111a and 111b establish a direct peer-to-peer connection between nodes 110a and 110b.

In some cases, a broker server may be used to open ports in user firewalls such that the direct connections may be established between peers. Whenever a direct exchange is not possible, a relay, which is represented by node 110c, may be leveraged to relay the connection in real-time. A relay connection between nodes 110a and 110b is shown via node 110c. A relay server may be made available by a service provider, or alternatively any peer could take on the relay role. Such computers may also have rendezvous server functionality such that the users at nodes 110a and 110b may find each other, establish presence (e.g. online/offline, available, busy, invisible), and establish a connection to exchange information. Persistent relay server functionality may also be put in place such that information may be temporarily stored and forwarded, for example, when node 110a sends information to node 110b that is not online at the same time.

Software service providers may also utilize an enterprise server 130 such that, for instance, company and user accounts may be managed. The nodes 110a-c may connect to the server 130 via a network if a connection to the network is available.

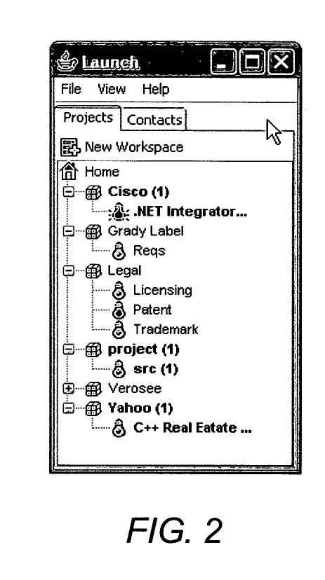

According to an embodiment, the system 100 enables users to collaborate by sharing information in natural ways, whereby the information may be organized and represented in multiple levels in a hierarchy. For example, FIG. 2 illustrates a hierarchy with projects at one level of the hierarchy and workspaces, at another level of the hierarchy, below each of the projects. A hierarchy is an organization of data with different levels. Parent-child relationships may be formed with data at different levels. One example of a hierarchy is a file system. For example, a folder may be a parent and a subfolder in the folder is a child of the parent. A project may include several workspaces. A workspace may include several folders and documents therein. A document may include any form of an electronic document.

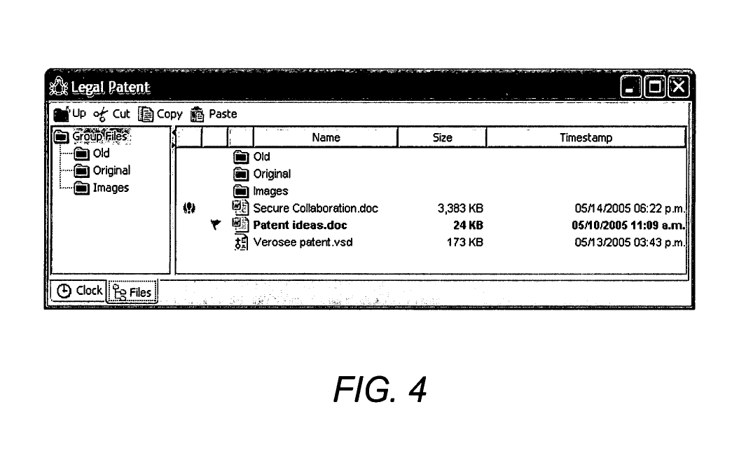

FIG. 2 shows a hierarchy for “Home” under the “Projects” tab. In “Home” there are several projects, such as “Cisco (1)”, “Grady Label”, “Legal”, “project (1)”, “Verosee”, and “Yahoo (1)”. Each project may include one or more workspaces, each with one or more subfolders or documents. For example, the “Legal” project includes “Licensing”, “Patent” and “Trademark” workspaces. Each workspace may contain hierarchy of folders and documents, further clarified in FIG. 4 for the “Legal” project “Patent” workspace.

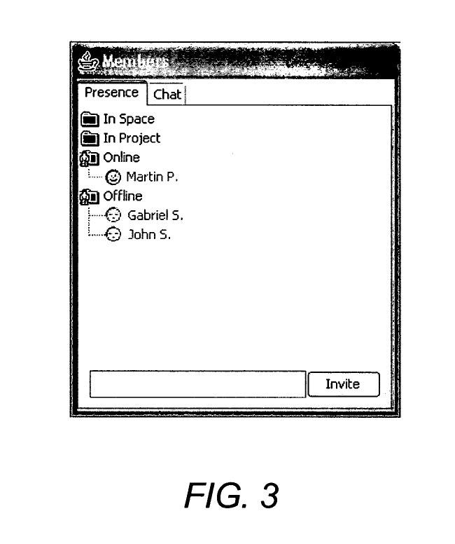

The presence of other users may be organized and represented in a hierarchy as well, such as shown in FIG. 3. Presence may include users that are currently being communicated or users that are related, such as users that are on the same project or the same workspace. FIG. 3 shows online and offline users. The hierarchy may include “In Space:” for a workspace level including contacts working in the same workspace, such as editing a shared file. The hierarchy may include “In Project:” for a project level for contacts accessing information in a different workspaces within the same project, or at the project level itself, such as configuring how a call to a project phone number may be routed to project members through Interactive Voice Response (IVR). “Otherwise Online:” includes users that are online but not in the previous categories, and “Offline:” includes users not online or, for example, users chosen to appear as invisible. Depending on the system architecture employed, the presence of other users may be established by peer-to-peer connections, or through central database lookups. Different levels of information may be accessible only to people with the proper security credentials. As a first step in obtaining those credentials, for instance, a workspace invitation protocol may be used to authenticate and accept people. Then, at the next level(s), for instance for projects, credentials may be obtained by anyone who is a member of a workspace therein. At the highest level, for instance the application itself, a different set of credentials may be used for each contact with whom the user may collaborate, potentially having authenticated this contact by other means such as a telephone call.

According to an embodiment, users can manipulate a hierarchy and version documents in ways that are familiar to users accustomed to the behavior of operating systems, such as Windows, even though these manipulations may be done in parallel by different people not connected to the same file system, a central server, or even with each other (e.g., offline). The manipulations of different users done in parallel, and at different times, on the same hierarchy are then synchronized when the users are connected, so users can have the same representation of the hierarchy.

An action is any change in a hierarchy, such as new/cut/delete/rename/move/paste/copy of: folders, files, workspaces, projects, or any other hierarchy level or information. An action may be initiated or performed by a user. An action may affect the organization of data in the hierarchy. Each action is given a timestamp, which is used to synchronize and create a representation of the hierarchy. Each representation of the hierarchy may also be given a timestamp when it is created. Actions may be time stamped at origin and a roll-back-and-forward method may be used to synchronize hierarchies and ensure information consistency for all users modifying common information. Since the times or clocks for individual user computers may be configured incorrectly, a client application is operable to check how far off the computer's time is from a universal time, for instance measured in Greenwich Mean Time (GMT) seconds since 1900, and adjust action timestamps by that amount.

FIG. 4 is an example of a hierarchy of information to be synchronized after actions are performed on documents, files or folders. For example, “Patent ideas.doc” may be edited and/or moved to a different folder. The file system and files are stored locally on each node along with representations of the hierarchies and representations of the actions and associated timestamps. The representations of the hierarchies may include snapshots of the file system at particular times. The file system may be altered by actions and a snapshot may represent an altered file system. Actions can be performed in parallel on the hierarchy at different times on the nodes, and then later synchronized.

Actions taken by users in parallel may be conflicting. For instance, a user u1 may put a file, such as “Patent ideas.doc” shown in FIG. 4, in folder “Old”, but another user on a different user device may put “Patent ideas.doc” in folder “Original”. Somehow the client application for each of the user devices needs to ultimately show the same folder hierarchy taking into account actions for all the users so they may continue collaborating effectively. Further, these actions may be communicated from user device to user device not in the order that the actions occurred, since people may dynamically come in and out of the peer-to-peer network and computers could process actions without a central synchronizing server, particularly in a peer-to-peer system. So, a user u1 may take an action X at a time t1, and a user u2 may takes a action Y at a later time t2, and a user u3 may receive Y before X, and yet somehow the same folder hierarchy must be shown on all the user devices after the actions are communicated between the user devices.

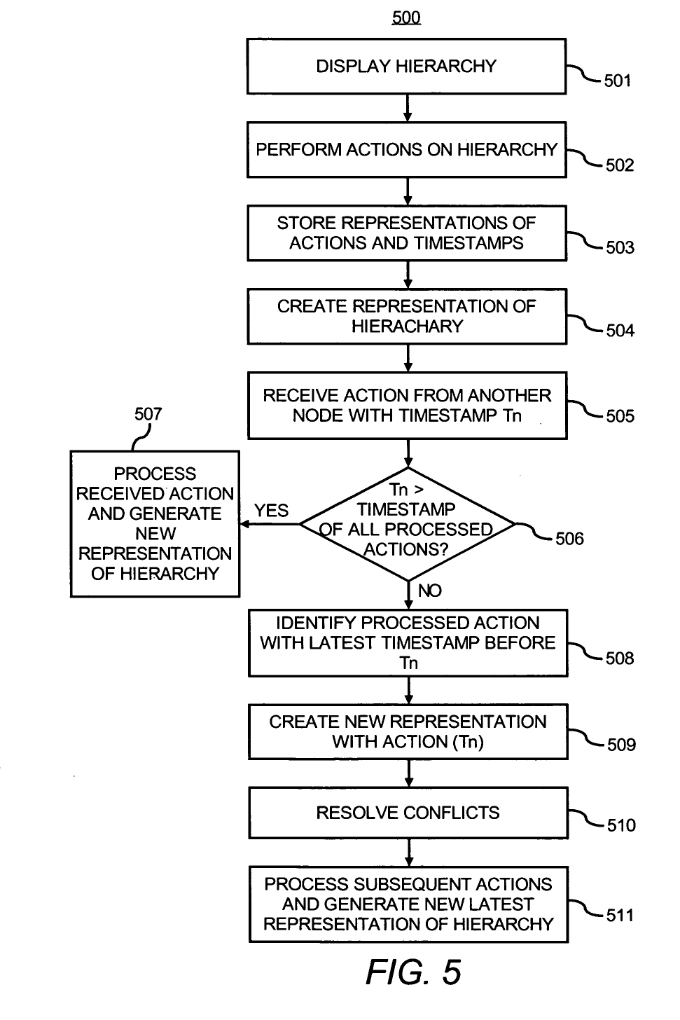

According to an embodiment, actions may be synchronized to generate a representation of hierarchy that includes actions from different users, such that the users can view the same hierarchy as needed when collaborating or performing other functions. FIG. 5 illustrates a method 500 for generating a synchronized representation of a hierarchy according to an embodiment. The method 500 is described with respect to the system 100 by way of example and not limitation.

At step 501, user devices, such as the nodes 110a and 110b, store files and folders in a hierarchy and are operable to display a representation of the hierarchy. Each device may initially store the same hierarchy. Examples of representations of a hierarchy are shown in FIGS. 2-4.

At step 502, actions on the hierarchy are performed on the node 110a, for example, by a user of the node 110a. At step 503, the actions are stored in the node 110a, each with a timestamp of when the action was performed. Storing an action may include storing an indication of the action that was performed. At step 504, the actions are processed to create a representation of the hierarchy, which includes the modifications on the hierarchy resulting from the action. The modifications on the hierarchy are modifications on a previous state of the hierarchy, prior to the actions being performed. That state of the hierarchy may be represented by a previous representation of the hierarchy. A representation of the hierarchy may be generated for each new action.

At step 505, the node 110a receives an action performed on the same hierarchy from the node 110b. The action may be received, for example, after the nodes 110a and 110b are reconnected via a peer-to-peer connection, or relayed via node 110c. Receiving an action may include receiving an indication of an action that was performed on another node and a timestamp for the action. The received action includes a timestamp Tn.

The steps 506-511 described below include one embodiment for synchronizing hierarchies from different devices, such as the nodes 110a and 110b. For example, the nodes 110a and 110b start with the same hierarchy, which is stored locally on each device. Each of the hierarchies are modified, for example, by different actions performed on each of the nodes 110a and 110b. Then, the hierarchies are synchronized, for example, by synchronizing the actions performed on each of the nodes 110a and 110b, and a representation of the synchronized hierarchies may be generated on each of the nodes 110a and 110b. Also, the steps 506-511 described synchronizing a single action received from the node 110b. It will be apparent to one of ordinary skill in the art that more than one action received from more than one node may be synchronized using the method 500.

At step 506, a determination is made as to whether Tn of the received action is later than the timestamps for all the processed actions used to create the most recent representation.

If the timestamp Tn is later, then the received action is processed and a new representation is generated at step 507. If the timestamp Tn is before at least one the processed actions, a processed action with the latest timestamp that is earlier than Tn is identified at step 508. This may include identifying the representation including all the actions before Tn. For example, processed actions may have timestamps of 12:01, 12:05 and 12:10. If Tn is 12:06, the timestamp 12:05 is identified and/or a representation of the hierarchy resulting from the actions of 12:01 and 12:05 is identified. In step 509, the action with timestamp Tn is processed on the identified representation, and a new representation of the hierarchy is created. For example, the identified representation of the hierarchy, which is the representation of the hierarchy resulting from the actions of 12:01 and 12:05, is used as a starting point. The action with timestamp Tn is processed on the identified representation, and a new representation of the hierarchy is created which includes the action with timestamp Tn.

At step 510, conflicts are resolved if any. For example, a determination is made as to which action to process first if two have identical time stamps. In another example, a conflict may arise if two actions are performed on the same object. For example, an action performed on the node 110a is deleting a file, and an action performed on the node 110b is moving the same file. When the actions from the nodes 110a and 110b are synchronized, the file may be considered deleted and thus may not be shown on the final representation of the hierarchy. In one embodiment, conflict resolution rules for resolving conflicts may be determined on a case-by-case basis for conflicts arising if two actions are performed on the same object.

Conflict resolution performed at the step 510 is not necessarily performed after step 509 and before step 511. The conflict resolution performed at the step 510 may be performed whenever an action is processed, such as during step 509 and during step 511. Generally, one or more of the steps of the method 500 may be performed in an order other than shown in the method 500 or performed simultaneously with other steps.

At step 511 all the actions subsequent to the action with Tn are processed and a new representation is generated representing the hierarchy with all the processed actions. In one embodiment, a representation is generated for each processed action, and the final representation includes all the processed actions.

As described with respect to the method 500, an automated rollback procedure may be performed to generate a new representation of the hierarchy if the received action occurred prior to any of the processed actions. Also, unique IDs may be assigned to files, folders, projects, workspaces, or any other object. This helps determine the location of the object for generating a representation. In the example described above, user u1 may put a file, such as “Patent ideas.doc” shown in FIG. 4, in folder “Old” at T1. Disconnected user u2 on a different user device may rename folder “Old” to “Old Junk” at a later time T2. Disconnected user u1 may then put “Patent ideas.doc” in folder “Old” at a later time T3. During synchronization, when processing the actions, folder and files may be found in the file system using their IDs, so that all users may then see “Patent ideas.doc” inside the folder “Old Junk”.

Also, when synchronizing hierarchies, duplicate actions may not be not processed. Only one of the duplicate actions may be processed. For example, the node 110a may receive representations of actions from the node 110b. The representations of actions may include action performed on the node 110c, which were previously received from the node 110c. The node 110a may receive the same representations of actions sent directly from the node 110c, or relayed via another peer 110b. Each action may be identified by a unique ID and/or user ID. Duplicate representations of actions received at node 110a, which may be identified by the IDs, may not be processed. Only one of the duplicate actions may be processed. The synchronization of information may be performed on representations and actions for types of data other than hierarchies, and is applicable for synchronizing information those types of data.

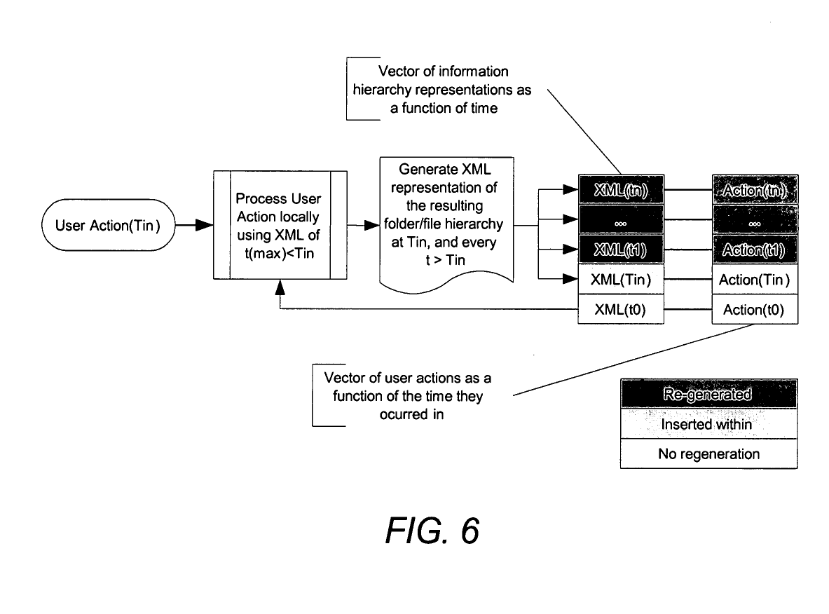

FIG. 6 represents a data flow diagram for generating a synchronized representation of a hierarchy. Every time a user takes an action, whether its the local user or any other user operating on the same information, a representation of the action and a representation of the resulting hierarchy is generated and associated to the action that brought it about, both of which are stored locally. The representations may be in XML or other format.

FIG. 6 shows the action with timestamp Tin that is received. As long as the incoming action occurred at a time (Tin) that is later than the time of the latest processed action (tmax), the new representation of the hierarchy will be produced using the latest representation of the hierarchy, including all the processed actions up to XML (tmax). If Tin is earlier than tmax, then a rollback is performed. For example, the actions are reorganized from earliest to latest and are processed in order to generate a new representation of the hierarchy. As shown, XML (t0) is not regenerated. Instead, XML (t0) is used as the starting point for the next processing of the action (Tin), which occurred between t0 and t1, and subsequent actions are processed. All subsequent actions may be processed, including resolution of conflicts. For example, a later move of a file may be ignored if the file was deleted at an earlier time by another user.

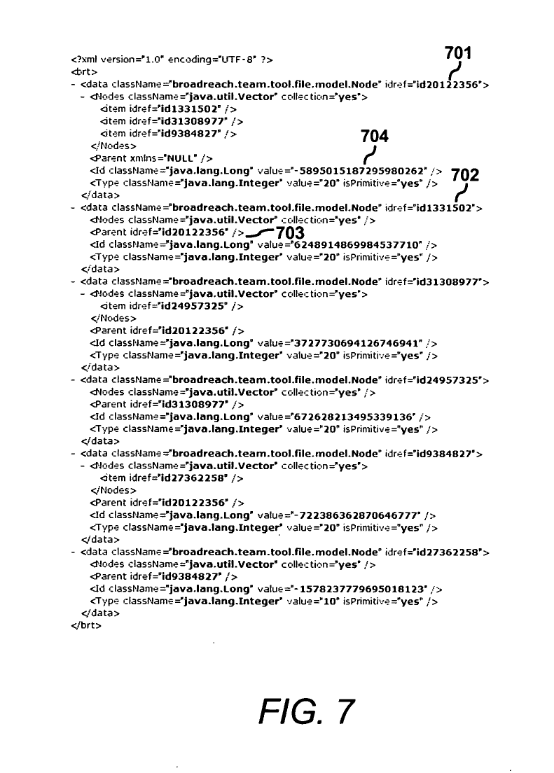

FIG. 7 illustrates an example of an XML representation 700 of a hierarchy. The XML representation 700 includes, for example, IDs of folders at different or same levels of the hierarchy. For example, 701 is an ID for a folder at a root of the hierarchy. 702 is a folder that is a child of 701. 703 provides an indication that 701 is the parent of 702. 704 is a database ID of where related things are stored.

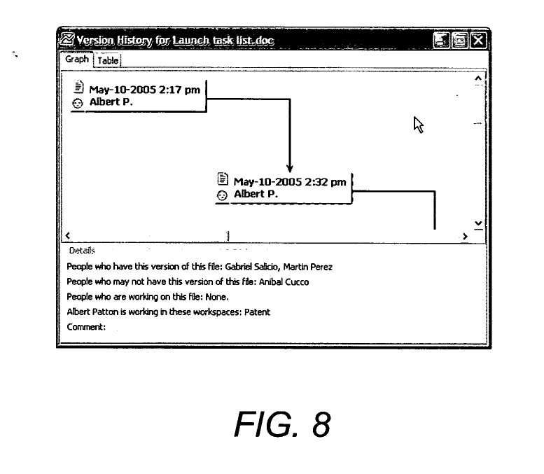

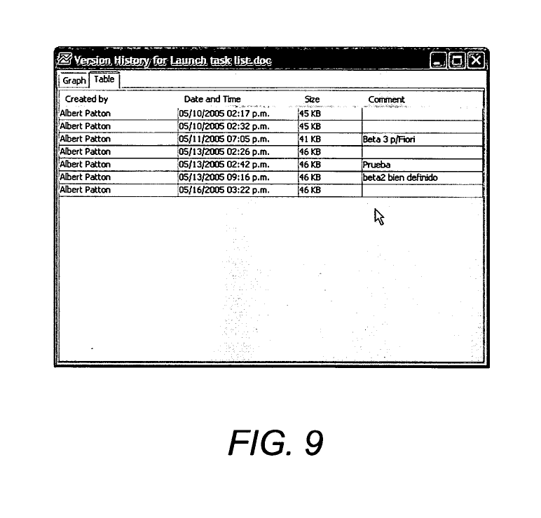

According to an embodiment, different versions of a same document are synchronized, so that the document may be modified arbitrarily by several people asynchronously in parallel. The document may be in a hierarchy that is synchronized. This is achieved by showing a single file in the folder where it is placed, but keeping logically attached the versions that have been edited by different people. Each version may then carry its own attributes, such as comments. FIG. 8 shows a graph of document versions created by different people. FIG. 9 shows a table of document versions created by different people.

A critical aspect is determining which of the related versions may become the main version of the logical file, i.e., the one that is opened when the object (e.g., document or file) is selected (e.g., double-clicked) from the folder it is in. This may be done in several ways, for instance: a) by allowing one or more people with access to the file to select any related version and promote it as the main version; b) by having the application of each person with access to the file automatically determine which related version was created first, using the file's timestamp, and promoting it to be the new main version. Whenever a version is promoted to be the main one, the version (one promoted to be main) is the version of the file that is opened when the file is selected. Promoting a file to be main may be performed by identifying the version to be main through an attribute. Also, any new modifications of the logical file may be captured in related versions of the main one, and the related versions are grandchildren of the original main. A user device may receive an indication that a version has been promoted to main, for example, during synchronization of hierarchies. Then, that version is marked as the main.

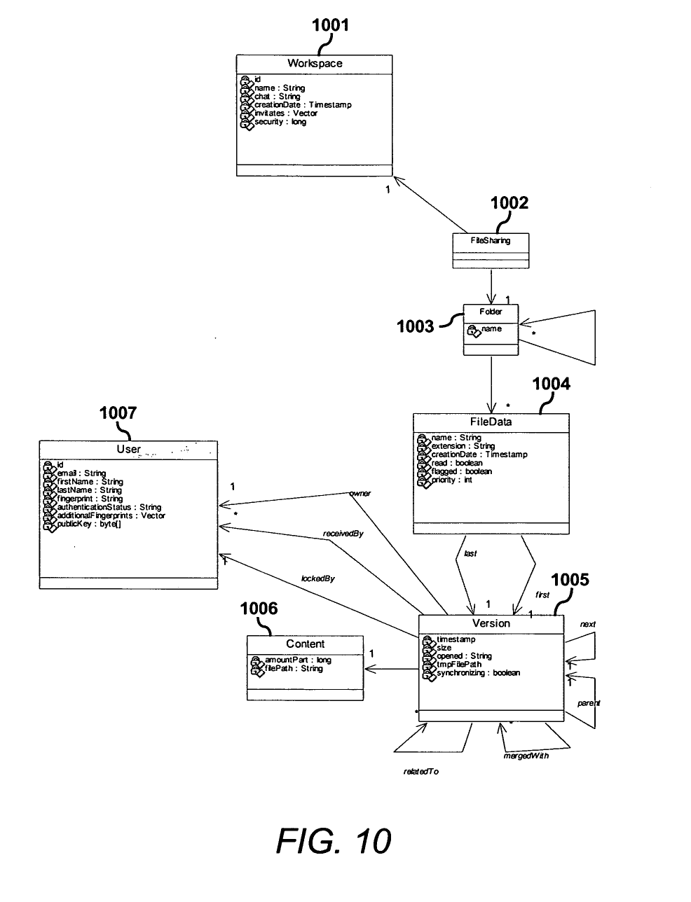

FIG. 10 shows a data model for a workspace file sharing tool and shows how data objects are related. A workspace 1001 is shown with attributes. Attributes are shown for each of the boxes underneath the titles of the boxes. Box 1002 represents that the workspace 1001 allows file sharing and includes a folder 1003. A file 1004 may be included in the folder 1003. The file 1004 may be the logical file, which the current main file that is opened when the file is selected. Box 1005 represents a version of the file 1004 including content 1006. The asterisks and 1's shown in FIG. 10 indicate plurality of single respectively. For example, as shown in FIG. 10, the version 1005 may be related to more than one file and merged with more than one file. The version 1005 may have a single parent. A single user 1007 may own and lock the version 1005, but the version 1005 may be received by more than one user.

Prior art software for establishing connections between devices, such as MSN messenger or Yahoo messenger, is remarkably complicated and requires several manual steps be performed to contact and communicate with a user that does not initially have the software installed. For example, some conventional messenger software requires a user that is being sent a message but that does not have the software installed, to go to a website, download and install the software, write down the user ID of the person that was contacting him/her, and then input that user ID as a contact after the software is installed.

According to an embodiment, one-click invitations provide an automated procedure for a user receiving an invitation to install communication software and communicate with the inviter with a single click. For example, when a user invites another user of the application, perhaps using their current email address, the invitation may be routed to the invitee in a peer-to-peer fashion by first looking up the invitee's ID in a server, such as the server 130 shown in FIG. 1. The invitation may be routed without server intermediation if both users are online at the same time and can directly address each other. Alternatively, the invitation can be routed with the intermediation of a real-time relay, such as the node 110c, if the users can not directly address each other. Or it could be routed with the intermediation of a persistent relay server that may store an invitation event with all the relevant information about the invitation for the invitee if he is not online at the same time.

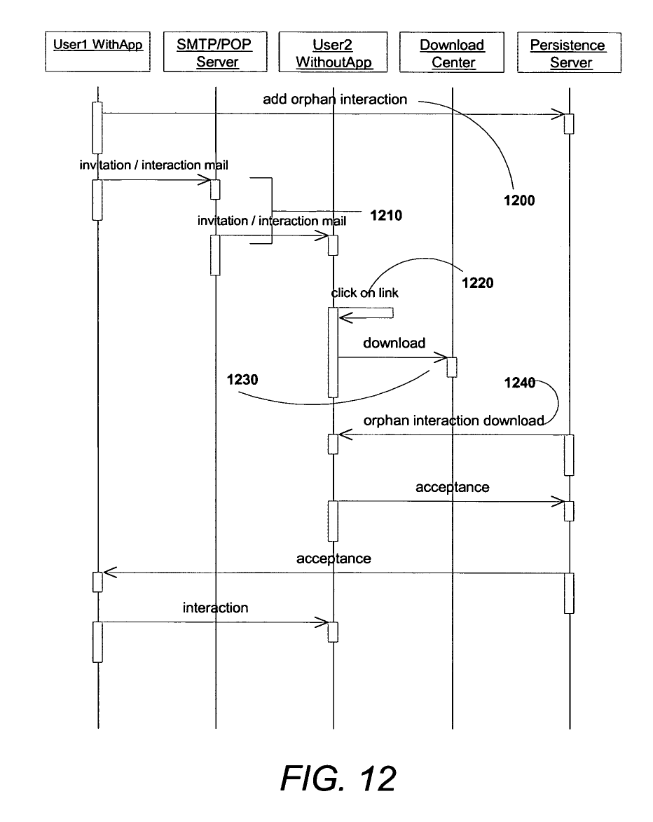

As described above, when the invitee is not a user of the software, the invitation process is straight forward and only requires a single click, such as clicking a link in the invitation. FIG. 12 illustrates a link in an invitation that may be clicked to automatically download, install and establish communication with the inviter. Instead of a link, any clickable indication of acceptance of the invitation may be used, such as a button. Also, requiring only a single-click to accept the invitation is preferred. However, other selection criteria may be used, such as double-click or one or more keystrokes.

FIG. 12 illustrates the invitation process according to an embodiment. At steps 1200 and 1210 a non-user receives an invitation and an orphan invitation event is performed. For example, the inviter desires to communicate with a user using the communication software, which may be messenger software or some other communication software. The inviter's application, knowing the user's email address, searches an enterprise server, such as the server 130 shown in FIG. 1, for the user's email address to determine whether that user has the communication software. If a determination is made that the user does not have the communication software, the inviter's application sends an invitation to the user, and an orphan invitation event is created.

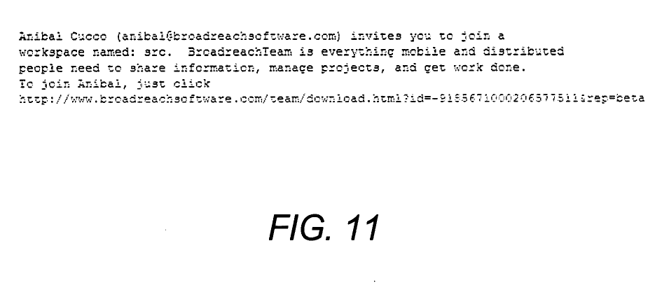

This may be accomplished by having the inviter's application store an orphan invitation event in a persistent relay server, or other means of storage, until the invitee has had a chance to create his identity, and retrieve this event. Utilizing a standard means such as Java Network Launching Protocol (JNLP), clicking the link at step 1220 can trigger the downloading of the application. As part of the link or in some equivalent way, arguments such as the orphan invitation event ID may be passed to the invitee's machine and stored locally, potentially in the operating system's registry. Once the application has installed, and the invitee has created his identity, his/her application may become aware of these events and retrieve them from the persistent relay server using a key such as the user's email address. The users may then complete the invitation and mutual authentication process as necessary. After using the method shown in FIG. 11 to establish communication, two devices may communicate with each other to perform one or more functions, including synchronizing hierarchies and actions described with respect to the method 500. For example, all the actions and a representation of a hierarchy generated from the actions is sent with the invitation and may be used to synchronize information in the devices.

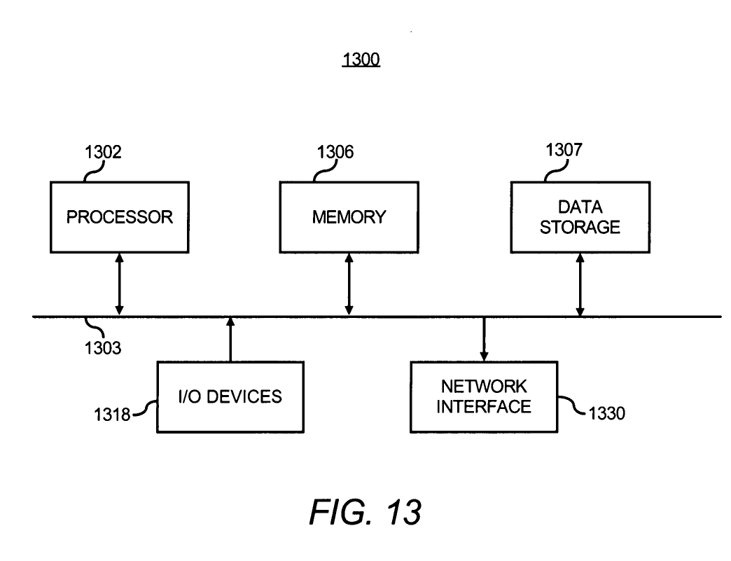

FIG. 13 illustrates a schematic block diagram of a computer system 1300, according to an embodiment. The computer system 1300 may include one or more processors, such as processor 1302, providing an execution platform for executing software. The computer system 1300 also includes a memory 1306, which may include Random Access Memory (RAM) where software is resident during runtime. The computer system 1300 also includes data storage 1307, which may include one or more of ROM (read only memory), EPROM (erasable, programmable ROM), EEPROM (electrically erasable, programmable ROM) hard disks, etc. A bus 1303 is also shown.

A user interfaces with the computer system 1300 with one or more input/output (I/O) devices 1318, such as a keyboard, a mouse, a stylus, a display, and the like. A network interface and/or other type of interface 1330 is provided for communicating with other computer systems. It will be apparent to one of ordinary skill in the art that FIG. 13 is meant to illustrate a generic computer system. Any type of computer system may be used. Furthermore, one or more components of the components of the computer system 1300 are optional, such as the display and input devices, and other types of components may be used or substituted as is known in the art. In one embodiment, the computer system 1300 represents a node in a network, which may be one of the nodes 130a-c shown in FIG. 1.

One or more of the steps of the method 500 and other steps described herein, including steps shown in FIG. 12, as well as the client applications described herein may be implemented as software embedded or stored on a computer readable medium, such as the memory 1306 or data storage 1307, and executed by the processor 1302. The steps may be embodied by a computer program, which may exist in a variety of forms both active and inactive. For example, there may exist as software program(s) comprised of program instructions in source code, object code, executable code or other formats for performing some of the steps when executed. Any of the above may be stored on a computer readable medium, which include storage devices and signals, in compressed or uncompressed form. Examples of suitable computer readable storage devices include conventional computer system RAM (random access memory), ROM (read only memory), EPROM (erasable, programmable ROM), EEPROM (electrically erasable, programmable ROM), and magnetic or optical disks or tapes. Examples of computer readable signals, whether modulated using a carrier or not, are signals that a computer system hosting or running the computer program may be configured to access, including signals downloaded through the Internet or other networks. Concrete examples of the foregoing include distribution of the programs on a CD ROM or via Internet download. In a sense, the Internet itself, as an abstract entity, is a computer readable medium. The same is true of computer networks in general. It is therefore to be understood that those functions enumerated herein may be performed by any electronic device capable of executing the above-described functions.

Those skilled in the art will recognize that variations of the embodiments are possible within the scope as defined in the following claims and their equivalents.

What is claimed is:

1. A method of synchronizing actions from multiple devices to generate a representation, wherein each device initially stores the same initial representation, the method comprising:
generating a representation, which includes modifications on the initial representation resulting from performing any actions on the initial representation in a first device;
receiving an action from a second device, wherein the action was performed in the second device on the initial representation stored in the second device;
synchronizing the actions performed on the second device with the actions performed on the first device; and
generating a new representation including the synchronized actions from the first and second devices.

2. The method of claim 1, further comprising:
storing the actions performed on the initial representation in the first device and timestamps for each action;
storing the action performed on the second device along with a timestamp, Tn, for the action; and
synchronizing includes synchronizing the action performed on the second device with the actions performed on the first device using the timestamps for each of the actions.

3. The method of claim 2, further comprising:
storing a plurality of representations and associated timestamps on the first device, wherein each representation is generated after each of the actions is performed on the first device:
determining whether Tn is before a latest representation on the first device;
identifying the representation with a latest timestamp before Tn in response to determining Tn is before the latest representation; and
using the identified representation as a starting point, processing the action with the timestamp Tn to generate a new representation.

4. The method of claim 3, further comprising:
processing all actions subsequent to Tn to generate the representation.

5. The method of claim 3, further comprising:
in response to determining that Tn is after the latest representation, processing the action with the timestamp Tn to generate the new representation using the latest representation as a starting point.

6. The method of claim 1, further comprising:
receiving an action performed on a third device; and
synchronizing the action performed on the third device with the actions performed on the first and second devices to generate a second new representation.

7. The method of claim 6, further comprising:
storing all the received actions performed on the representation from the second and third devices;
storing the actions performed on the representation in the first device;
storing at least one unique ID for each of the actions, wherein each of the at least one unique IDs identify the action performed and a user performing the action; and
using the stored at least one unique ID for each of the expressions to determine whether expressions for duplicate actions performed by the same user are stored; and
only processing one of the duplicate actions to generate the new representation if duplicate actions are identified.

8. The method of claim 1, further comprising:
identifying conflicting actions that occurred at the same time or on the same object; and
ordering actions based on pre-set rules or only processing one of the conflicting actions to generate the new representation.

9. The method of claim 8, wherein the one processed action is the later of the conflicting actions.

10. The method of claim 1, wherein the representation comprises the same files stored in the same folders on each of the first and second devices.

11. The method of claim 10, wherein at least some of the folders have a parent-child relationship forming a hierarchy.

12. The method of claim 10, further comprising:
storing a document and versions of the document in a folder in the first and second devices;
processing an indication that a version of the document is promoted as main from the first or second device, which is the document that is opened when the document is selected; and
receiving a user selection of the document at the first device; and
opening the main at the first device.

13. The method of claim 12, wherein the version is promoted to main based on a determination of a user.

14. The method of claim 12, wherein the version is promoted to main based on a comparison of creation times with other versions.

15. The method of claim 1, wherein the initial representation, the generated representation and the new representation are representations of a hierarchy.

16. A computer readable medium storing executable instructions which, when executed by a processor, causes the processor to perform a method of synchronizing actions from multiple devices to generate a representation, wherein each device initially stores the same initial representation, the method comprising:
generating a representation, which includes modifications on the initial representation resulting from performing any actions on the initial representation in a first device;
receiving an action from a second device, wherein the action was performed in the second device on the initial representation stored in the second device;
synchronizing the actions performed on the second device with the actions performed on the first device; and
generating a new representation including the synchronized actions from the first and second devices.

17. The computer readable medium of claim 16, wherein the method further comprises:
storing the actions performed on the initial representation in the first device and timestamps for each action;
storing the action performed on the second device along with a timestamp, Tn, for the action; and
synchronizing includes synchronizing the action performed on the second device with the actions performed on the first device using the timestamps for each of the actions.

18. The computer readable medium of claim 17, wherein the method further comprises:
storing a plurality of representations and associated timestamps on the first device, wherein each representation is generated after each action of the actions is performed on the first device:
determining whether Tn is before a latest representation on the first device;
identifying a representation with a latest timestamp before Tn in response to determining Tn is before the latest representation;
using the identified representation as a starting point, processing the action with the timestamp Tn to generate a new representation; and
processing all actions subsequent to Tn to generate the new representation.

19. The computer readable medium of claim 16, wherein the method further comprises:
receiving an invitation to communicate from a user of the application, wherein the invitation includes a clickable indication of acceptance of the invitation;
in response to clicking on the indication, automatically downloading and installing the application on the non-user's device, such that the non-user is operable to use the application to communicate with a sender of the invitation; and
the sender communicating, at the time of the invitation, all known actions and a representation generated from all the actions; and
synchronizing the action performed on the second device with all the actions known by the sender to generate the new representation.

20. A method for inviting a non-user of an application to communicate, the method comprising:
receiving an invitation to communicate from a user of the application, wherein the invitation includes a clickable indication of acceptance of the invitation; and
in response to clicking on the link, automatically downloading and installing the application on the non-user's device, such that the non-user may use the application to communicate with a sender of the invitation.
receiving an orphan invitation event ID with the invitation;
after installing the downloaded application, retrieving the orphan event from a third party using the event ID; and
identifying the sender of the invitation from a third party to communicate with the sender using the application.
